(19) United States
(12) Patent Application Publication
(10) Pub. No.: US 2017/0076645 A1
(43) Pub. Date: Mar. 16, 2017

(54) DISCHARGE LAMP DRIVING DEVICE, PROJECTOR, AND DISCHARGE LAMP DRIVING METHOD

(71) Applicant: SEIKO EPSON CORPORATION, Tokyo (JP)

(72) Inventors: Tetsuo TERASHIMA, Azumino-Shi (JP); Yoichi NAKAGOMI, Matsumoto-Shi (JP)

(73) Assignee: SEIKO EPSON CORPORATION, Tokyo (JP)

(21) Appl. No.: 15/254,361

(22) Filed: Sep. 1, 2016

(30) Foreign Application Priority Data
Sep. 11, 2015 (JP) 2015-179710

(51) Int. Cl. G09G 3/00; G03B 21/00; G03B 21/20; H05B 41/36

(52) U.S. Cl. CPC G09G 3/002; H05B 41/36; G03B 21/006; G03B 21/2053; G03B 21/2026; G09G 2310/0254

(57) ABSTRACT

In an aspect of a discharge lamp driving device, the controller is configured to supply a driving current to a discharge lamp, the driving current alternately having a first period and a second period. The first period includes a plurality of consecutive first unit driving periods each of which is constituted of a first polarity period and a second polarity period. The second period includes a plurality of consecutive second unit driving periods. In the first unit driving period, a length of one polarity period is larger than the other polarity period, and a duration ratio which is a ratio of the length of the one polarity period to the length of the other polarity period is equal to or more than a predetermined value. In the second unit driving period, the duration ratio is equal to or more than 1, and is less than the predetermined value.

### BACKGROUND

1. Technical Field

The present invention relates to a discharge lamp driving device, a light source device, a projector, and a discharge lamp driving method.

2. Related Art

A problem is known in which, if a lamp voltage is reduced due to deterioration in a discharge lamp, an electrode is unlikely to be melted, and thus a protrusion of an electrode tip is thinned so that deterioration in the discharge lamp is accelerated.

In relation to this problem, for example, as disclosed in JP-A-2011-23288, a method has been proposed in which a DC current is inserted into an AC current supplied to a discharge lamp, and a DC current component is increased according to the progress of a deterioration state of the discharge lamp.

However, in the above-described method, since a melting amount of a protrusion of an electrode tip serving as an anode is improved due to the DC current but the temperature of an electrode serving as a cathode is reduced, there is a problem in that a shape of an electrode tip serving as the cathode is deformed, and thus flickering occurs. Therefore, there is a case where the lifespan of the discharge lamp may not be sufficiently lengthened.

### SUMMARY

An advantage of some aspects of the invention is to provide a discharge lamp driving device which can improve the lifespan of a discharge lamp, a light source device including the discharge lamp driving device, and a projector including the light source device. Another advantage of some aspects of the invention is to provide a discharge lamp driving method capable of improving the lifespan of a discharge lamp.

An aspect of a discharge lamp driving device according to the invention includes a discharge lamp driving unit configured to supply a driving current to a discharge lamp provided with a first electrode and a second electrode; and a controller configured to control the discharge lamp driving unit. The controller is configured to supply the driving current to the discharge lamp, the driving current alternately having a first period and a second period in which an AC current is supplied to the discharge lamp. The first period includes a plurality of consecutive first unit driving periods each of which is constituted of a first polarity period in which the first electrode serves as an anode and a second polarity period in which the second electrode serves as an anode. The second period includes a plurality of consecutive second unit driving periods each of which is constituted of the first polarity period and the second polarity period. In the first unit driving period, a length of one of the first polarity period and the second polarity period is larger than the other polarity period, and a duration ratio which is a ratio of the length of the one polarity period to the length of the other polarity period is equal to or more than a predetermined value. In the second unit driving period, the duration ratio is equal to or more than 1, and is less than the predetermined value.

According to the aspect of the discharge lamp driving device according to the invention, in the first unit driving period constituting the first period, the ratio of the length of the one polarity period to the length of the other polarity period is equal to or more than a predetermined value. Thus, in the first period, it is possible to improve a melting amount of a protrusion at a tip of an electrode serving as an anode in the one polarity period. On the other hand, the other polarity period which is shorter than the one polarity period and in which an opposite polarity occurs is provided in each of the plurality of first unit driving periods included in the first period, and thus it is possible to minimize a decrease in the temperature of an electrode serving as an anode in the other polarity period. Consequently, it is possible to prevent a protrusion at a tip of the other electrode from being deformed and thus to minimize the occurrence of flickering.

According to the aspect of the discharge lamp driving device according to the invention, since a melting amount of the protrusion at the tip of the electrode on the heated side can be improved, and the protrusion at the tip of the electrode on the opposite side to the heated side can be prevented from being deformed so that the occurrence of flickering is minimized, it is possible to provide the discharge lamp driving device capable of improving the lifespan of the discharge lamp.

The second period and the first period are alternately provided, the second period including a plurality of consecutive second unit driving periods in which a ratio between the length of the first polarity period and the length of the second polarity period is less than a predetermined value. Thus, a protrusion melted in the first period tends to thickly and stably grow in the second period. Therefore, according to the aspect of the discharge lamp driving device according to the invention, it is possible to further improve the lifespan of the discharge lamp.

The aspect may be configured such that the second period has a first frequency period and a second frequency period each of which includes at least one second unit driving period in which the duration ratio is 1, and a first frequency of an AC current in the first frequency period is different from a second frequency of an AC current in the second frequency period.

According to this configuration, it is possible to make the protrusion of the electrode more appropriately grow in the second period.

The aspect may be configured such that, in the second period, a frequency of the AC current supplied to the discharge lamp temporally changes.

According to this configuration, it is possible to make the protrusion of the electrode more appropriately grow in the second period.

The aspect may be configured such that the second period has a DC period in which a DC current is supplied to the discharge lamp, and a length of the DC period is larger than a length of a half cycle of an AC current with the first frequency and a length of a half cycle of an AC current with the second frequency.

According to this configuration, it is possible to make the protrusion of the electrode more appropriately grow in the second period.

The aspect may be configured such that the first period includes a first AC period in which the length of the first polarity period is larger than the length of the second polarity period in the first unit driving period, and a second AC period in which the length of the second polarity period is larger than the length of the first polarity period in the first unit driving period, and the first AC period and the second AC period are alternately provided with the second period interposed therebetween.

According to this configuration, it is possible to melt both of the first electrode and the second electrode with good balance.

The aspect may be configured such that the discharge lamp driving device further includes a detection unit configured to detect an inter-electrode voltage of the discharge lamp, and the controller changes at least one of the length of the first period and the length of the second period according to at least one of detected inter-electrode voltage, and driving power supplied to the discharge lamp.

According to this configuration, it is possible to appropriately melt the first electrode and the second electrode and make protrusions of the electrodes grow according to a change in an inter-electrode voltage or a change in driving power.

The aspect may be configured such that the controller changes the length of the first period according to the detected inter-electrode voltage, and the length of the first period is increased according to an increase of the inter-electrode voltage in a range in which the inter-electrode voltage is equal to or lower than a first predetermined voltage, and is decreased according to the increase of the inter-electrode voltage in a range in which the inter-electrode voltage is higher than the first predetermined voltage.

According to this configuration, it is possible to appropriately melt the first electrode and the second electrode and make protrusions of the electrodes grow according to a change in an inter-electrode voltage.

The aspect may be configured such that the controller changes the length of the second period according to the detected inter-electrode voltage, and the length of the second period is decreased according to an increase of the inter-electrode voltage in a range in which the inter-electrode voltage is equal to or lower than a second predetermined voltage, and is increased according to the increase of the inter-electrode voltage in a range in which the inter-electrode voltage is higher than the second predetermined voltage.

According to this configuration, it is possible to appropriately melt the first electrode and the second electrode and make protrusions of the electrodes grow according to a change in an inter-electrode voltage.

The aspect may be configured such that the second predetermined voltage is lower than the first predetermined voltage.

According to this configuration, in a case where the discharge lamp deteriorates to some extent, it is possible to appropriately melt the first electrode and the second electrode and make protrusions of the electrodes grow.

The aspect may be configured such that the discharge lamp driving device further includes a detection unit configured to detect an inter-electrode voltage of the discharge lamp, and the controller changes the duration ratio in the first period according to at least one of detected inter-electrode voltage, and driving power supplied to the discharge lamp.

According to this configuration, it is possible to appropriately melt the first electrode and the second electrode and make protrusions of the electrodes grow according to a change in an inter-electrode voltage or a change in driving power.

The aspect may be configured such that the controller changes the duration ratio according to the detected inter-electrode voltage, and the duration ratio is increased according to an increase of the inter-electrode voltage in a range in which the inter-electrode voltage is equal to or lower than a third predetermined voltage, and is decreased according to the increase of the inter-electrode voltage in a range in which the inter-electrode voltage is higher than the third predetermined voltage.

According to this configuration, it is possible to appropriately melt the first electrode and the second electrode and make protrusions of the electrodes grow according to a change in an inter-electrode voltage.

The aspect may be configured such that the discharge lamp driving device further includes a detection unit configured to detect an inter-electrode voltage of the discharge lamp, and the controller changes the length of the DC period according to at least one of detected inter-electrode voltage, and driving power supplied to the discharge lamp.

According to this configuration, it is possible to make protrusions of the electrodes more appropriately grow according to a change in an inter-electrode voltage or a change in driving power in the second period.

An aspect of a light source device according to the invention includes a discharge lamp configured to emit light; and the discharge lamp driving device described above.

According to the aspect of the light source device according to the invention, the discharge lamp driving device is provided therein, and thus it is possible to provide the light source device capable of improving the lifespan of the discharge lamp.

An aspect of a projector according to the invention includes the light source device described above; a light modulation device configured to modulate light emitted from the light source device according to an image signal; and a projection optical system configured to project light modulated by the light modulation device.

According to the aspect of the projector according to the invention, the light source device is provided therein, and thus it is possible to provide the projector capable of improving the lifespan of the discharge lamp.

An aspect of a discharge lamp driving method according to the invention, the method for supplying a driving current to a discharge lamp provided with a first electrode and a second electrode and driving the discharge lamp, includes repeating alternately a first period and a second period in which an AC current is supplied to the discharge lamp. The first period includes a plurality of consecutive first unit driving periods each of which is constituted of a first polarity period in which the first electrode serves as an anode and a second polarity period in which the second electrode serves as an anode. The second period includes a plurality of consecutive second unit driving periods each of which is constituted of the first polarity period and the second polarity period. In the first unit driving period, a length of one of the first polarity period and the second polarity period is larger than the other polarity period, and a duration ratio which is a ratio of the length of the one polarity period to the length of the other polarity period is equal to or more than a predetermined value. In the second unit driving period, the duration ratio is equal to or more than 1, and is less than the predetermined value.

According to the aspect of the discharge lamp driving method according to the invention, it is possible to improve the lifespan of the discharge lamp as described above.

### BRIEF DESCRIPTION OF THE DRAWINGS

The invention will be described with reference to the accompanying drawings, wherein like numbers reference like elements.

FIG. 1 is a schematic configuration diagram illustrating a projector according to a first embodiment.

FIG. 2 is a sectional view illustrating a discharge lamp in the first embodiment.

FIG. 3 is a block diagram illustrating various constituent elements of the projector according to the first embodiment.

FIG. 4 is a circuit diagram illustrating a discharge lamp lighting device according to the first embodiment.

FIG. 5 is a block diagram illustrating a configuration example of a controller according to the first embodiment.

FIGS. 6A and 6B are diagrams illustrating states of protrusions of electrode tips of the discharge lamp.

FIG. 7 is a diagram illustrating an example of a driving current waveform according to the first embodiment.

FIG. 8 is a diagram illustrating another example of a driving current waveform according to the first embodiment.

FIG. 9 is a diagram illustrating an example of a driving current waveform according to a second embodiment.

### DESCRIPTION OF EXEMPLARY EMBODIMENTS

Hereinafter, with reference to the drawings, a projector according to embodiments of the invention will be described.

The scope of the invention is not limited to the following embodiments, and can be arbitrarily changed within the scope of the technical spirit of the invention. In the following drawings, for better understanding of each constituent element, a scale, the number, and the like thereof in each structure may be different from a scale, the number, and the like thereof in an actual structure.

### First Embodiment

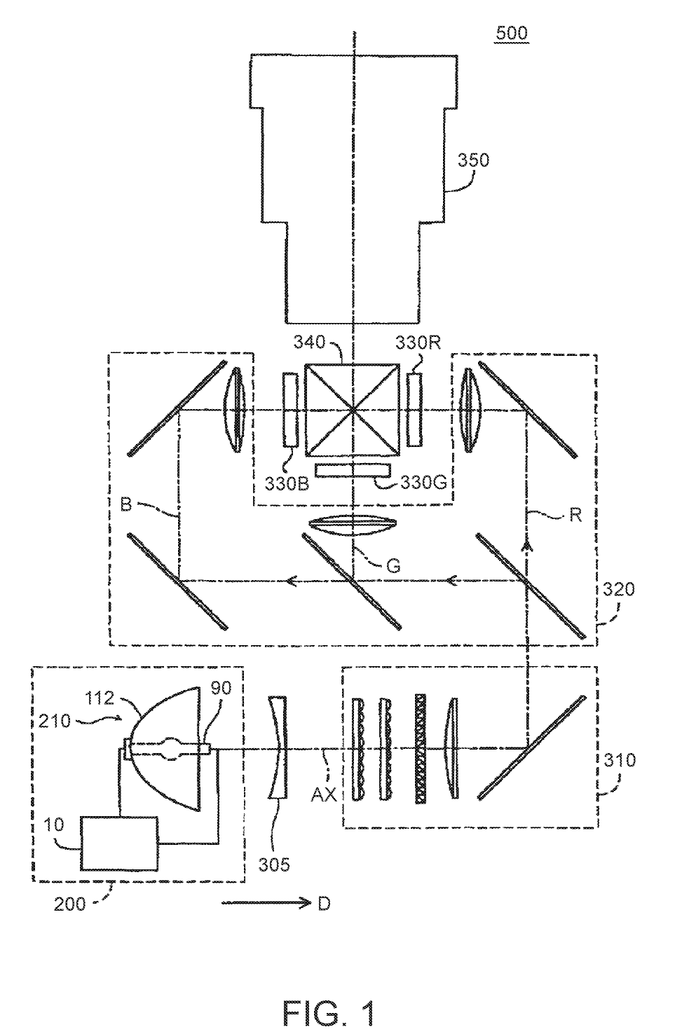

As illustrated in FIG. 1, a projector 500 of the present embodiment includes a light source device 200, a collimating lens 305, an illumination optical system 310, a color separation optical system 320, three liquid crystal light valves (light modulation devices) 330R, 330G and 330B, a cross dichroic prism 340, and a projection optical system 350.

Light emitted from the light source device 200 passes through the collimating lens 305 and is incident to the illumination optical system 310. The collimating lens 305 collimates the light from the light source device 200.

The illumination optical system 310 adjusts the illuminance of the light emitted from the light source device 200 so that the illuminance is uniformized on the liquid crystal light valves 330R, 330G and 330B. The illumination optical system. 310 aligns polarization directions of the light emitted from the light source device 200 in one direction. This is aimed at effectively using the light emitted from the light source device 200 in the liquid crystal light valves 330R, 330G and 330B.

The light having undergone the adjustment of the illuminance distribution and the polarization directions is incident to the color separation optical system 320. The color separation optical system 320 separates the incident light into three color light beams including red light (R), green light (G), and blue light (B). The three color light beams are respectively modulated according to video signals by the liquid crystal light valves 330R, 330G and 330B which correspond to the respective color light beams. The liquid crystal light valves 330R, 330G and 330B respectively include liquid crystal panels 560R, 560G and 560B which will be described later, and polarization plates (not illustrated). The polarization plates are disposed on a light incidence side and a light emission side of each of the liquid crystal panels 560R, 560G and 560B.

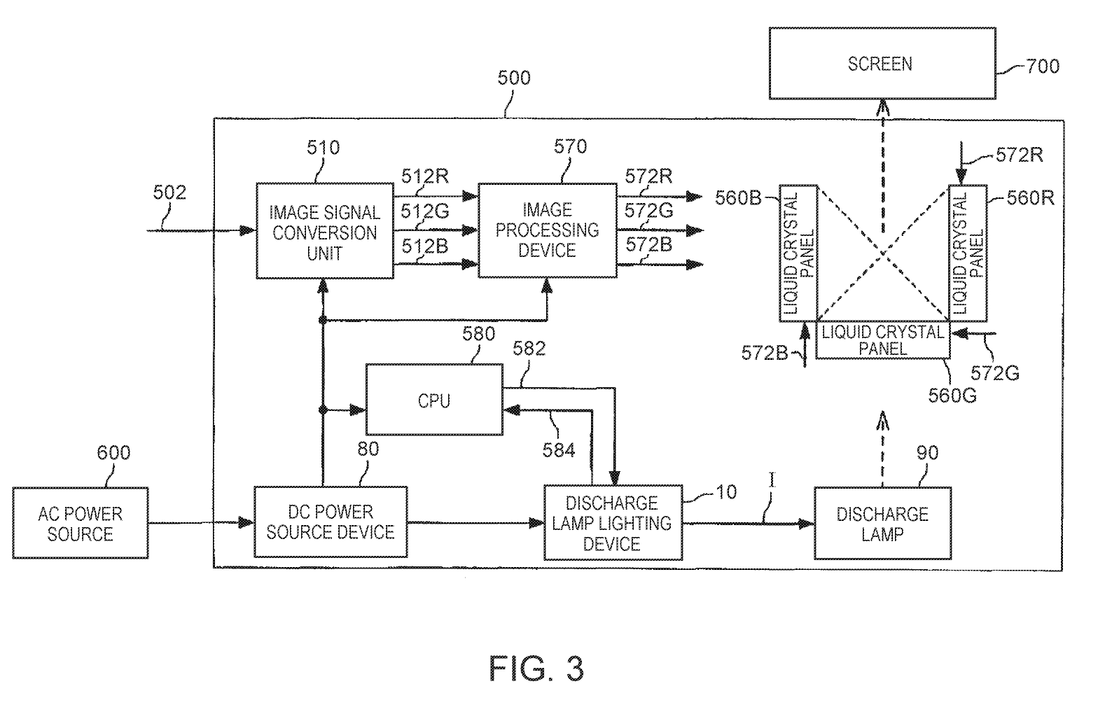

The three modulated color light beams are combined with each other by the cross dichroic prism 340. The combined light is incident to the projection optical system 350. The projection optical system 350 projects the incident light onto a screen 700 (refer to FIG. 3). Thus, a video is displayed on the screen 700. In addition, well-known configurations may be employed as configurations of the collimating lens 305, the illumination optical system 310, the color separation optical system 320, the cross dichroic prism 340, and the projection optical system 350.

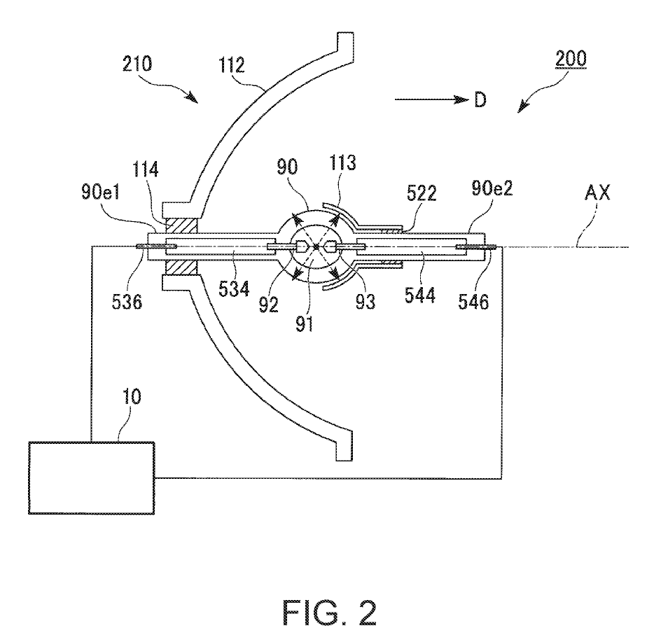

FIG. 2 is a sectional view illustrating a configuration of the light source device 200. The light source device 200 includes a light source unit 210 and a discharge lamp lighting device (discharge lamp driving device) 10. FIG. 2 shows a sectional view of the light source unit 210. The light source unit 210 includes a main reflection mirror 112, a discharge lamp 90, and a subsidiary reflection mirror 113.

The discharge lamp lighting device 10 supplies a driving current I to the discharge lamp 90 so as to light the discharge lamp 90. The main reflection mirror 112 reflects light emitted from the discharge lamp 90 in an irradiation direction D. The irradiation direction D is parallel to an optical axis AX of the discharge lamp 90.

The discharge lamp 90 has a rod shape extending in the irradiation direction D. One end of the discharge lamp 90 is referred to as a first end 90e1, and the other end of the discharge lamp 90 is referred to as a second end 90e2. A material of the discharge lamp 90 is, for example, a light transmissive material such as quartz glass. A central portion of the discharge lamp 90 is swollen in a spherical shape, and the inside thereof is a discharge space 91. A gas which is a discharge medium containing rare gases, metal halogen compounds, and the like is enclosed in the discharge space 91.

Tips of a first electrode 92 and a second electrode 93 protrude in the discharge space 91. The first electrode 92 is disposed on the first end 90e1 side of the discharge space 91. The second electrode 93 is disposed on the second end 90e2 side of the discharge space 91. Each of the first electrode 92 and the second electrode 93 has a rod shape extending in the optical axis AX. The tips of the first electrode 92 and the second electrode 93 are disposed to face each other with a predetermined distance in the discharge space 91. A material of each of the first electrode 92 and the second electrode 93 is, for example, a metal such as tungsten.

A first terminal 536 is provided at the first end 90e1 of the discharge lamp 90. The first terminal 536 and the first electrode 92 are electrically connected to each other via a conductive member 534 which penetrates through the discharge lamp 90. Similarly, a second terminal 546 is provided at the second end 90e2 of the discharge lamp 90. The second terminal 546 and the second electrode 93 are electrically connected to each other via a conductive member 544 which penetrates through the discharge lamp 90. A material of each of the first terminal 536 and the second terminal 546 is, for example, a metal such as tungsten. As a material of each of the conductive members 534 and 544, for example, a molybdenum foil is used.

The first terminal 536 and the second terminal 546 are connected to the discharge lamp lighting device 10. The discharge lamp lighting device 10 supplies the driving current I for driving the discharge lamp 90 to the first terminal 536 and the second terminal 546. As a result, arc discharge occurs between the first electrode 92 and the second electrode 93. Light (discharge light) occurring due to the arc discharge is radiated in all directions from the discharge position as indicated by dashed arrows.

The main reflection mirror 112 is fixed to the first end 90e1 of the discharge lamp 90 via a fixation member 114. The main reflection mirror 112 reflects light which travels toward an opposite side to the irradiation direction D among discharge light beams, in the irradiation direction D. A shape of a reflection surface (a surface on the discharge lamp 90 side) of the main reflection mirror 112 is not particularly limited within a range in which discharge light can be reflected in the irradiation direction D, and may be, for example, a spheroidal shape or a rotating parabolic shape. For example, in a case where a shape of the reflection surface of the main reflection mirror 112 is a rotating parabolic shape, the main reflection mirror 112 can convert discharge light into light which is substantially parallel to the optical axis AX. Consequently, the collimating lens 305 can be omitted.

The subsidiary reflection mirror 113 is fixed to the second end 90e2 side of the discharge lamp 90 via a fixation member 522. A shape of a reflection surface (a surface on the discharge lamp 90 side) of the subsidiary reflection mirror 113 is a spherical shape which surrounds a portion of the discharge space 91 on the second end 90e2 side. The subsidiary reflection mirror 113 reflects light which travels toward an opposite side to the side on which the main reflection mirror 112 is disposed among the discharge light beams, toward the main reflection mirror 112. Consequently, it is possible to increase usage efficiency of the light radiated from the discharge space 91.

A material of each of the fixation members 114 and 522 is not particularly limited as long as the material is a heat resistant material which can resist heat generated from the discharge lamp 90, and is, for example, an inorganic adhesive. A method of fixing the main reflection mirror 112, the subsidiary reflection mirror 113, and the discharge lamp 90 to each other is not limited to a method in which the main reflection mirror 112 and the subsidiary reflection mirror 113 are fixed to the discharge lamp 90, and may employ any method. For example, the discharge lamp 90 and the main reflection mirror 112 may be separately fixed to a casing (not illustrated) of the projector 500. This is also the same for the subsidiary reflection mirror 113.

Hereinafter, a circuit configuration of the projector 500 will be described.

FIG. 3 is a diagram illustrating an example of a circuit configuration of the projector 500 according to the present embodiment. The projector 500 includes an image signal conversion unit 510, a DC power source device 80, the liquid crystal panels 560R, 560G and 560B, an image processing device 570, and a central processing unit (CPU) 580, in addition to the optical systems illustrated in FIG. 1.

The image signal conversion unit 510 converts image signals 502 (luminance-color difference signals, analog RGB signals, or the like) which are input from an external device into digital RGB signals with a predetermined word length so as to generate image signals 512R, 512G and 512B which are then supplied to the image processing device 570.

The image processing device 570 performs an image process on each of the three image signals 512R, 512G and 512B. The image processing device 570 supplies driving signals 572R, 572G and 572B for respectively driving the liquid crystal panels 560R, 560G and 560B, to the liquid crystal panels 560R, 560G and 560B.

The DC power source device 80 converts an AC voltage supplied from an external AC power source 600 into a constant DC voltage. The DC power source device 80 supplies DC voltages to the image signal conversion unit 510 and the image processing device 570 located on a secondary side of a transformer (not illustrated but included in the DC power source device 80) and the discharge lamp lighting device 10 located on a primary side of the transformer.

The discharge lamp lighting device 10 generates a high voltage between the electrodes of the discharge lamp 90 so as to cause dielectric breakdown and thus form a discharge path during activation. Thereafter, the discharge lamp lighting device 10 supplies the driving current I for the discharge lamp 90 maintaining discharge.

The liquid crystal panels 560R, 560G and 560B are respectively provided in the above-described liquid crystal light valves 330R, 330G and 330B. The liquid crystal panels 560R, 560G and 560B modulate transmittance (luminance) of the color light beams which are respectively incident to the liquid crystal panels 560R, 560G and 560B via the above-described optical systems on the basis of the respective driving signals 572R, 572G and 572B.

The CPU 580 controls various operations from starting of lighting of the projector 500 to putting-out thereof. For example, in the example illustrated in FIG. 3, a lighting command or a putting-out command is output to the discharge lamp lighting device 10 via a communication signal 582. The CPU 580 receives lighting information of the discharge lamp 90 from the discharge lamp lighting device 10 via a communication signal 584.

Hereinafter, a description will be made of a configuration of the discharge lamp lighting device 10.

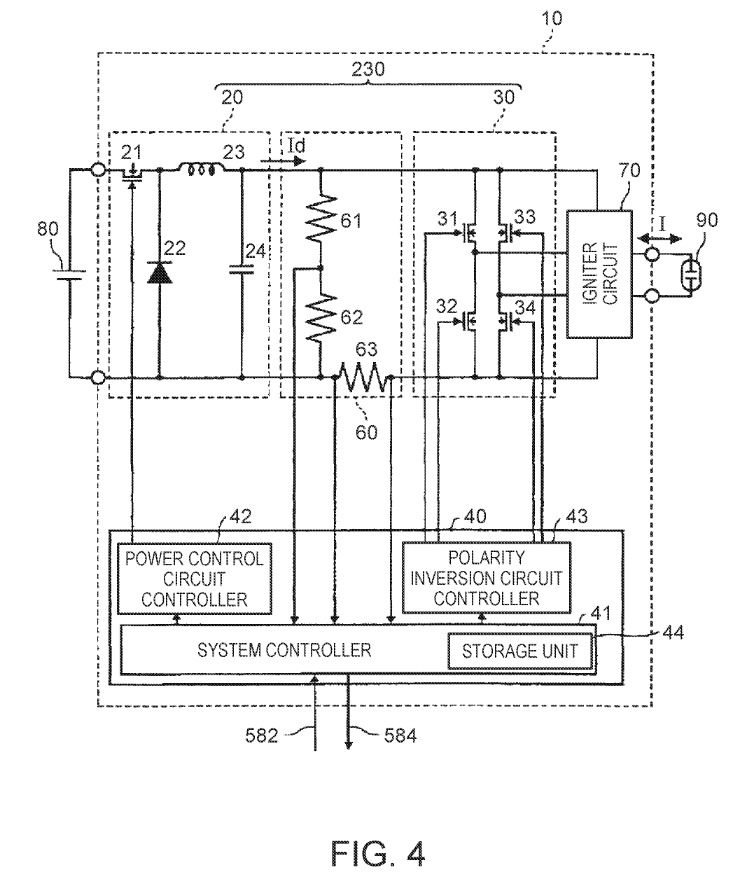

FIG. 4 is a diagram illustrating an example of a circuit configuration of the discharge lamp lighting device 10.

The discharge lamp lighting device 10 includes, as illustrated in FIG. 4, a power control circuit 20, a polarity inversion circuit 30, a controller 40, an operation detection unit 60, and an igniter circuit 70.

The power control circuit 20 generates driving power Wd which is supplied to the discharge lamp 90. In the present embodiment, the power control circuit 20 is constituted of a down chopper circuit which receives a voltage from the DC power source device 80 and outputs a DC current Id by stepping down the input voltage.

The power control circuit 20 is configured to include a switch element 21, a diode 22, a coil 23, and a capacitor 24. The switch element 21 is constituted of, for example, a transistor. In the present embodiment, one end of the switch element 21 is connected to a positive voltage side of the DC power source device 80, and the other end thereof is connected to a cathode terminal of the diode 22 and one end of the coil 23.

One end of the capacitor 24 is connected to the other end of the coil 23, and the other end of the capacitor 24 is connected to an anode terminal of the diode 22 and a negative voltage side of the DC power source device 80. A current control signal is input to a control terminal of the switch element 21 from the controller 40 which will be described later, and thus turning-on and turning-off of the switch element 21 are controlled. As the current control signal, for example, a pulse width modulation (PWM) control signal may be used.

If the switch element 21 is turned on, a current flows through the coil 23, and thus energy is accumulated in the coil 23. Thereafter, if the switch element 21 is turned off, the energy accumulated in the coil 23 is released along a path passing through the capacitor 24 and the diode 22. As a result, the DC current Id is generated which is proportional to a time period in which the switch element 21 is turned on.

The polarity inversion circuit 30 inverts a polarity of the DC current Id which is input from the power control circuit 20, at a predetermined timing. Consequently, the polarity inversion circuit 30 generates and outputs a driving current I as a DC which is continuously maintained only for a controlled time period, or a driving current I as an AC which has any frequency. In the present embodiment, the polarity inversion circuit 30 is constituted of an inverter bridge circuit (full bridge circuit).

The polarity inversion circuit 30 includes, for example, a first switch element 31, a second switch element 32, a third switch element 33, and a fourth switch element 34, constituted of transistors. The polarity inversion circuit 30 has a configuration in which the first switch element 31 and the second switch element 32 which are connected in series to each other are connected in parallel to the third switch element 33 and the fourth switch element 34 which are connected in series to each other. A polarity inversion control signal is input from the controller 40 to each of control terminals of the first switch element 31, the second switch element 32, the third switch element 33, and the fourth switch element 34. Turning-on and turning-off operations of each of the first switch element 31, the second switch element 32, the third switch element 33, and the fourth switch element 34 are controlled on the basis of the polarity inversion control signal.

In the polarity inversion circuit 30, an operation is repeatedly performed in which the first switch element 31 and the fourth switch element 34, and the second switch element 32 and the third switch element 33 are alternately turned on or off. Therefore, the polarities of the DC current Id output from the power control circuit 20 are alternately inverted. The polarity inversion circuit 30 generates and outputs a driving current I as a DC which is continuously maintained in the same polarity state only for a controlled time period or a driving current I as an AC having a controlled frequency, from a common connection point between the first switch element 31 and the second switch element 32, and a common connection point between the third switch element 33 and the fourth switch element 34.

In other words, in the polarity inversion circuit 30, the second switch element 32 and the third switch element 33 are controlled to be turned off when the first switch element 31 and the fourth switch element 34 are turned on, and the second switch element 32 and the third switch element 33 are controlled to be turned on when the first switch element 31 and the fourth switch element 34 are turned off. Thus, the driving current I is generated which flows in order of the first switch element 31, the discharge lamp 90, and the fourth switch element 34 from one end of the capacitor 24 when the first switch element 31 and the fourth switch element 34 are turned on. The driving current I is generated which flows in order of the third switch element 33, the discharge lamp 90, and the second switch element 32 from one end of the capacitor 24 when the second switch element 32 and the third switch element 33 are turned on.

In the present embodiment, the portion including the power control circuit 20 and the polarity inversion circuit 30 corresponds to a discharge lamp driving unit 230. In other words, the discharge lamp driving unit 230 supplies the driving current I for driving the discharge lamp 90 to the discharge lamp 90.

The controller 40 controls the discharge lamp driving unit 230. In the example illustrated in FIG. 4, the controller 40 controls the power control circuit 20 and the polarity inversion circuit 30 so as to control parameters such as a retention duration in which the driving current I is continuously maintained to have the same polarity, and a current value (a power value of the driving power Wd) and a frequency of the driving current I. The controller 40 performs polarity inversion control for controlling a retention duration in which the driving current I is continuously maintained to have the same polarity, a frequency of the driving current I, and the like, on the polarity inversion circuit 30, on the basis of a polarity inversion timing of the driving current I. The controller 40 performs current control for controlling a current value of the output DC current Id on the power control circuit 20.

A configuration of the controller 40 is not particularly limited. In the present embodiment, the controller 40 is configured to include a system controller 41, a power control circuit controller 42, and a polarity inversion circuit controller 43. Some or all of the controllers of the controller 40 may be configured by using semiconductor integrated circuits.

The system controller 41 controls the power control circuit controller 42 and the polarity inversion circuit controller 43 so as to control the power control circuit 20 and the polarity inversion circuit 30. The system controller 41 may control the power control circuit controller 42 and the polarity inversion circuit controller 43 on the basis of a lamp voltage (a voltage between the electrodes) Vla and a driving current I detected by the operation detection unit 60.

In the present embodiment, the system controller 41 is connected to a storage unit 44.

The system controller 41 may control the power control circuit 20 and the polarity inversion circuit 30 on the basis of information stored in the storage unit 44. The storage unit 44 may store, for example, information regarding driving parameters such as a retention duration in which the driving current I is continuously maintained to have the same polarity, a current value, a frequency, a waveform, and a modulation pattern of the driving current I.

The power control circuit controller 42 outputs a current control signal to the power control circuit 20 on the basis of a control signal from the system controller 41, so as to control the power control circuit 20.

The polarity inversion circuit controller 43 outputs a polarity inversion control signal to the polarity inversion circuit 30 on the basis of a control signal from the system controller 41, so as to control the polarity inversion circuit 30.

The controller 40 may be implemented by using a dedicated circuit so as to perform the above-described control or various control operations related to processes to be described later. In contrast, the controller 40 functions as a computer, for example, by the CPU executing a control program stored in the storage unit 44, so as to perform various control operations related to such processes.

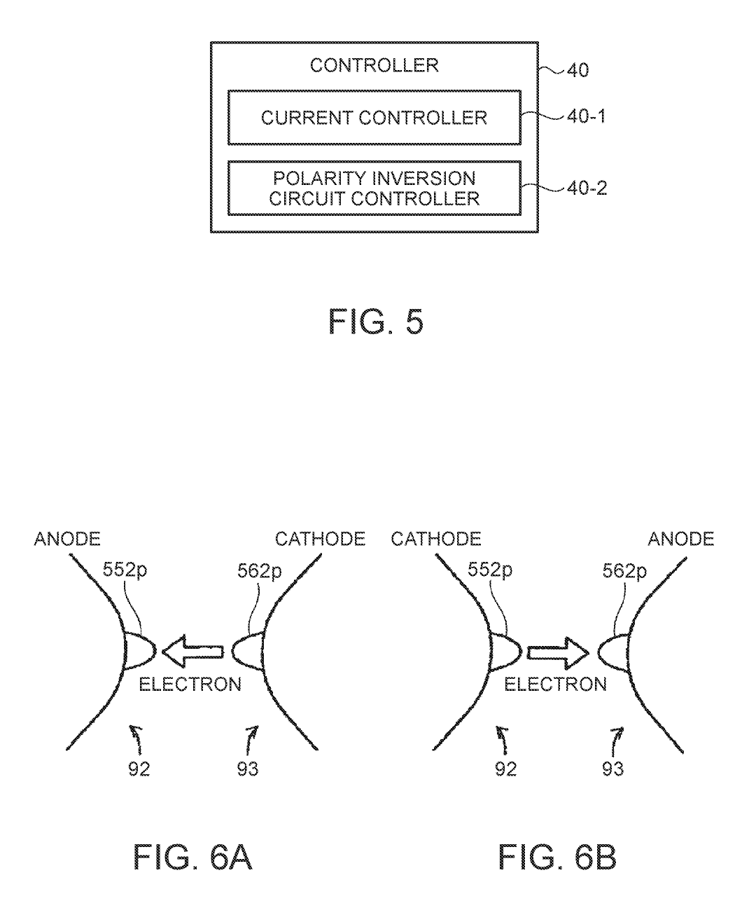

FIG. 5 is a diagram illustrating another configuration example of the controller 40. As illustrated in FIG. 5, the controller 40 may be configured to function as a current controller 40-1 which controls the power control circuit 20 and a polarity inversion circuit controller 40-2 which controls the polarity inversion circuit 30 according to the control program.

In the example illustrated in FIG. 4, the controller 40 is configured as a part of the discharge lamp lighting device 10. In contrast, the CPU 580 may be configured to realize some of the functions of the controller 40.

In the present embodiment, the operation detection unit 60 includes a voltage detection portion which detects a lamp voltage Vla of the discharge lamp 90 and outputs lamp voltage information to the controller 40. The operation detection unit 60 may include a current detection portion or the like which detects the driving current I and outputs driving current information to the controller 40. In the present embodiment, the operation detection unit 60 is configured to include a first resistor 61, a second resistor 62, and a third resistor 63.

In the present embodiment, the voltage detection portion of the operation detection unit 60 detects the lamp voltage Vla on the basis of a voltage divided by the first resistor 61 and the second resistor 62 which are connected in parallel to the discharge lamp 90 and are connected in series to each other. In addition, in the present embodiment, the current detection portion detects the driving current I on the basis of a voltage occurring at the third resistor 63 which is connected in series to the discharge lamp 90.

The igniter circuit 70 operates only at the time of starting of lighting of the discharge lamp 90. The igniter circuit 70 supplies a high voltage (a voltage higher than at normal lighting of the discharge lamp 90) which is necessary to cause dielectric breakdown between the electrodes (between the first electrode 92 and the second electrode 93) of the discharge lamp 90 and thus form a discharge path, between the electrodes of the discharge lamp 90 (between the first electrode 92 and the second electrode 93) at the time of starting of lighting of the discharge lamp 90. In the present embodiment, the igniter circuit 70 is connected in parallel to the discharge lamp 90.

FIGS. 6A and 6B illustrate the tips of the first electrode 92 and the second electrode 93. Protrusions 552p and 562p are respectively formed at the tips of the first electrode 92 and the second electrode 93.

Discharge occurring between the first electrode 92 and the second electrode 93 mainly occurs between the protrusion 552p and the protrusion 562p. In a case where the protrusions 552p and 562p are provided as in the present embodiment, movements of discharge positions (arc positions) at the first electrode 92 and the second electrode 93 can be minimized compared with a case where no protrusions are provided.

FIG. 6A illustrates a first polarity state in which the first electrode 92 operates as an anode, and the second electrode 93 operates as a cathode. In the first polarity state, electrons move from the second electrode 93 (cathode) to the first electrode 92 (anode) due to discharge. The electrons are emitted from the cathode (second electrode 93). The electrons emitted from the cathode (second electrode 93) collide with the tip of the anode (first electrode 92). Heat is generated due to the collision, and thus the temperature of the tip (protrusion 552p) of the anode (first electrode 92) increases.

FIG. 6B illustrates a second polarity state in which the first electrode 92 operates as a cathode, and the second electrode 93 operates as an anode. Contrary to the first polarity state, in the second polarity state, electrons move from the first electrode 92 to the second electrode 93. As a result, the temperature of the tip (protrusion 562p) of the second electrode 93 increases.

As mentioned above, when the driving current I is supplied to the discharge lamp 90, the temperature of the anode with which the electrons collide increases. On the other hand, the temperature of the cathode which emits the electrons decreases during emission of the electrons toward the anode.

An inter-electrode distance between the first electrode 92 and the second electrode 93 increases due to deterioration in the protrusions 552p and 562p. This is because the protrusions 552p and 562p wear. If the inter-electrode distance increases, resistance between the first electrode 92 and the second electrode 93 increases, and thus the lamp voltage Vla also increases. Therefore, by referring to the lamp voltage Vla, it is possible to detect a change in the inter-electrode distance, that is, the extent of deterioration in the discharge lamp 90.

Since the first electrode 92 and the second electrode 93 have the same configuration, in the following description, only the first electrode 92 will be described as a representative thereof in some cases. Since the protrusion 552p at the tip of the first electrode 92 and the protrusion 562p at the tip of the second electrode 93 have the same configuration, in the following description, only the protrusion 552p will be described in some cases.

Next, a description will be made of a case where the controller 40 controls the discharge lamp driving unit 230.

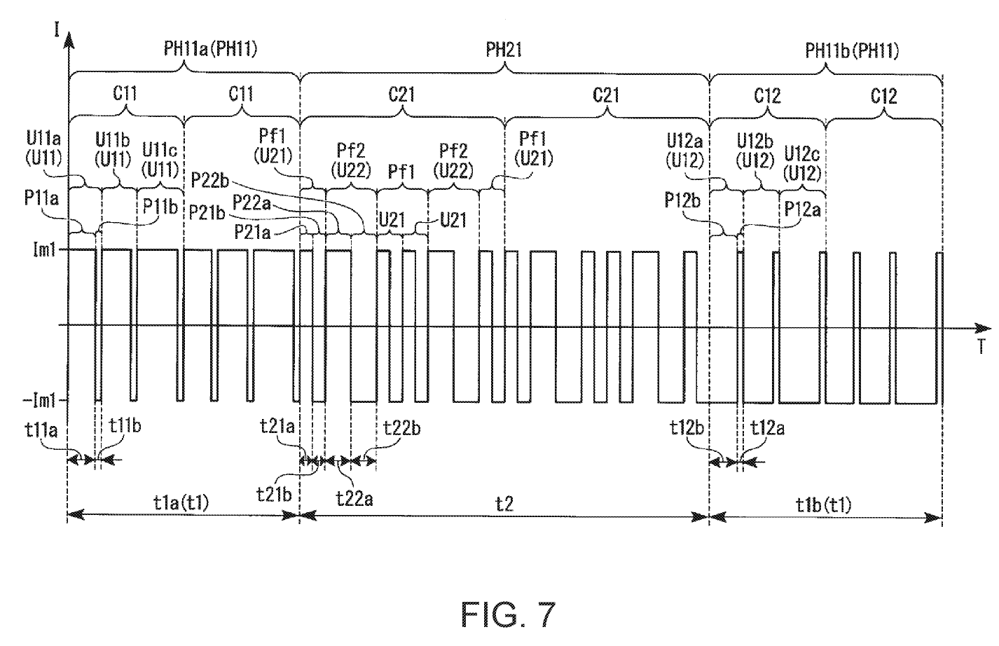

FIG. 7 is a diagram illustrating a driving current waveform of the driving current I supplied to the discharge lamp 90 of the present embodiment. In FIG. 7, a longitudinal axis expresses the driving current I, and a transverse axis expresses time T. In the present embodiment, the controller 40 controls the discharge lamp driving unit 230 according to the driving current waveform illustrated in FIG. 7.

As illustrated in FIG. 7, the driving current I alternately includes a first period PH11 and a second period PH21. The first period PH11 and the second period PH21 are periods in which an AC current whose polarity is inverted between a current value Im1 and a current value −Im1 is supplied to the discharge lamp 90 as the driving current I.

The first period PH11 includes a first AC period PH11a and a second AC period PH11b. The first AC period PH11a is a period in which the first electrode 92 is heated. The second AC period PH11b is a period in which the second electrode 93 is heated. The first AC period PH11a and the second AC period PH11b are alternately provided with the second period PH21 interposed therebetween.

The first AC period PH11a includes a plurality of consecutive first unit driving periods U11 each having a first polarity period P11a in which the first electrode 92 serves as an anode and a second polarity period P11b in which the second electrode 93 serves as an anode. In the present embodiment, the first AC period PH11a has a cycle C11 in which, for example, three first unit driving periods U11, that is, a first unit driving period U11a, a first unit driving period U11b, and a first unit driving periods U11c are continuously provided in this order. In the example illustrated in FIG. 7, the first AC period PH11a is constituted of two consecutive cycles C11.

The second AC period PH11b includes a plurality of consecutive first unit driving periods U12 each having a first polarity period P12a in which the first electrode 92 serves as an anode and a second polarity period P12b in which the second electrode 93 serves as an anode. In the present embodiment, the second AC period PH11b has a cycle C12 in which, for example, three first unit driving periods U12, that is, a first unit driving period U12a, a first unit driving period U12b, and a first unit driving periods U12c are continuously provided in this order. In the example illustrated in FIG. 7, the second AC period PH11b is constituted of two consecutive cycles C12.

In the driving current I of the present embodiment, the first AC period PH11a and the second AC period PH11b have the same waveform except that a polarity is inverted. In other words, a length t11a of the first polarity period P11a in each of the first unit driving periods U11a to U11c is the same as a length t12b of the second polarity period P12b in each of the first unit driving periods U12a to U12c. A length t11b of the second polarity period P11b in each of the first unit driving periods U11a to U11c is the same as a length t12a of the first polarity period P12a in each of the first unit driving periods U12a to U12c.

Thus, in the present embodiment, a length t1a of the first AC period PH11a is the same as a length t1b of the second AC period PH11b. In the present embodiment, each of the length t1a of the first AC period PH11a and the length t1b of the second AC period PH11b is set to, for example, 5.0 milliseconds (ms) or more. The length is set in the above-described way, and thus it is possible to improve melting amounts of the protrusion 552p and the protrusion 562p of the first electrode 92 and the second electrode 93.

In the present specification, the lengths of both of the periods being the same as each other includes not only a case where the lengths of both of the periods are exactly the same as each other but also a case where a ratio between the lengths of both of the periods is included in a range of being about 0.9 or more and 1.1 or less.

As described above, in the present embodiment, the first AC period PH11a and the second AC period PH11b have the same waveform except that a polarity is inverted, and, thus, in the following description, only the first AC period PH11a will be described as a representative thereof in some cases.

In the first unit driving periods U11 of the first AC period PH11a, the length t11a of the first polarity period P11a is larger than the length t11b of the second polarity period P11b, and a retention duration ratio Pkt which is a ratio of the length t11a of the first polarity period P11a to the length t11b of the second polarity period P11b is equal to or more than a predetermined value X (where X>1).

Consequently, in the first AC period PH11a having the plurality of consecutive first unit driving periods U11, a sum of the lengths t11a of the first polarity periods P11a is larger than a sum of the lengths t11b of the second polarity periods P11b. Therefore, in the first AC period PH11a, the first electrode 92 serving as an anode in the first polarity period P11a is heated.

In the present embodiment, for example, the predetermined value X is set to be equal to or more than 3.0. In other words, in the first AC period PH11a, the ratio (retention duration ratio Pkt) of the length t11a of the first polarity period P11a to the length t11b of the second polarity period P11b is equal to or more than 3.0.

The ratio is set in the above-described way, and thus it is possible to prevent the temperature of an electrode opposite to the heated electrode, that is, the second electrode 93 in the first AC period PH11a from decreasing, and also to further improve a melting amount of the first electrode 92 heated in the first AC period PH11a.

In the present embodiment, the length t11a of the first polarity period P11a in each of the first unit driving periods U11 is equal to or more than 1.0 ms. In other words, the length t11a of the first polarity period P11a is equal to or more than a length of a half cycle of an AC current with 500 Hz. Through the setting in the above-described way, it is possible to effectively improve a melting amount of the protrusion 552p at the tip of the first electrode 92.

The length t11a of the first polarity period P11a in the first unit driving period U11 is preferably equal to or less than 5.0 ms, that is, equal to or less than a length of a half cycle of an AC current with 100 Hz. This is because it is possible to effectively minimize a decrease in the temperature of the second electrode 93 which is a cathode in the first polarity period P11a.

In the present embodiment, the length t11b of the second polarity period P11b in each of the first unit driving periods U11 is, for example, equal to or more than about 0.16 ms and is less than 1.0 ms. In other words, the length t11b of the second polarity period P11b is equal to or more than a length of a half cycle of an AC current with 3 kHz, and is less than a length of a half cycle of an AC current with 500 Hz. Through the setting in the above-described way, it is possible to minimize a decrease in the temperature of the second electrode 93 and also to further improve a melting amount of the first electrode 92, in the first AC period PH11a.

In the present embodiments, for example, lengths of the first unit driving periods U11a to U11c are different from each other. In the present embodiment, for example, the lengths t11a of the first polarity periods P11a which are respectively included in the first unit driving periods U11a to U11c are different from each other. For example, the lengths t11b of the second polarity periods P11b which are respectively included in the first unit driving periods U11a to U11c are different from each other.

Table 1 shows examples of the length t11a of the first polarity period P11a and the length t11b of the second polarity period P11b of the first unit driving periods U11 in the first AC period PH11a. Table 1 also shows a ratio of the length t11a of the first polarity period P11a to the length t11b of the second polarity period P11b, that is, the retention duration ratio Pkt of the retention duration of the first polarity to the retention duration of the second polarity.

TABLE 1

| First unit | Length t11a | Length t11b | Retention duration ratio Pkt |
|---|---|---|---|
| driving | (ms) of first | (ms) of second | (length t11a of first polarity |
| periods | polarity | polarity | period/length t11b of second |
| U11 | period | period | polarity period) |
| U11a | 7 | 0.35 | 20 |
| U11b | 8 | 0.4 | 20 |
| U11c | 9 | 0.45 | 20 |

In Table 1, as an example, the length t11a of the first polarity period P11a and the length t11b of the second polarity period P11b are increased in order of the first unit driving period U11a to the first unit driving period U11c. In Table 1, for example, the retention duration ratios Pkt are the same as each other in all of the first unit driving periods U11.

In the first unit driving periods U12 of the second AC period PH11b, the length t12b of the second polarity period P12b is larger than the length t12a of the first polarity period P12a, and a retention duration ratio Pkt which is a ratio of the length t12b of the second polarity period P12b to the length t12a of the first polarity period P12a is equal to or more than the predetermined value X (where X>1).

Consequently, in the second AC period PH11b having the plurality of consecutive first unit driving periods U12, a sum of the lengths t12b of the second polarity periods P12b is larger than a sum of the lengths t12a of the first polarity periods P12a. Therefore, in the second AC period PH11b, the second electrode 93 serving as an anode in the second polarity period P12b is heated.

The second period PH21 has a first frequency period Pf1 and a second frequency period Pf2. In the present embodiment, the second period PH21 has a cycle C21 alternately including the first frequency period Pf1 and the second frequency period Pf2. In the example illustrated in FIG. 7, the second period PH21 is constituted of two consecutive cycles C21. In the example illustrated in FIG. 7, the cycle C21 includes three first frequency periods Pf1 and two second frequency periods Pf2.

The first frequency period Pf1 includes at least one second unit driving period U21. The second frequency period Pf2 includes at least one second unit driving period U22. In the example illustrated in FIG. 7, the first frequency period Pf1 includes one or two second unit driving periods U21. The second frequency period Pf2 includes one second unit driving period U22.

The first frequency period Pf1 and the second frequency period Pf2 including the second unit driving periods U21 and U22 are continuously provided, and thus the second period PH21 has a plurality of consecutive second unit driving periods.

The second unit driving period U21 is constituted of a first polarity period P21a in which the first electrode 92 serves as an anode and a second polarity period P21b in which the second electrode 93 serves as an anode. The second unit driving period U22 is constituted of a first polarity period P22a in which the first electrode 92 serves as an anode and a second polarity period P22b in which the second electrode 93 serves as an anode.

In the second unit driving period U21, a retention duration ratio Pkt which is a ratio of a length t21a of the first polarity period P21a to a length t21b of the second polarity period P21b is equal to or more than 1 and is less than the predetermined value X. This is also the same for the second unit driving period U22.

In the example illustrated in FIG. 7, the length t21a of the first polarity period P21a is the same as the length t21b of the second polarity period P21b. In other words, the retention duration ratio Pkt which is a ratio of the length t21a of the first polarity period P21a to the length t21b of the second polarity period P21b is 1. A length t22a of the first polarity period P22a is the same as a length t22b of the second polarity period P22b. Consequently, in the second period PH21 in the example illustrated in FIG. 7, for example, a rectangular wave AC current with a predetermined frequency of one cycle or two cycles is supplied to the discharge lamp 90. More specifically, the cycle C21 illustrated in FIG. 7 includes the first frequency period Pf1 in which an AC current with a first frequency f1 of one cycle is supplied to the discharge lamp 90, the second frequency period Pf2 in which an AC current with a second frequency f2 of one cycle is supplied to the discharge lamp 90, and the first frequency period Pf1 in which an AC current with the first frequency f1 of two cycles is supplied to the discharge lamp 90.

The first frequency f1 of the AC current supplied to the discharge lamp 90 in the first frequency period Pf1 is different from the second frequency f2 of the AC current supplied to the discharge lamp 90 in the second frequency period Pf2. In the example illustrated in FIG. 7, the first frequency f1 is higher than the second frequency f2.

In the cycle C21, the first frequency period Pf1 and the second frequency period Pf2 are alternately provided, and thus a frequency of the AC current supplied to the discharge lamp 90 repeatedly increases and decreases. In other words, in the second period PH21, a frequency of the AC current supplied to the discharge lamp 90 temporally increases and decreases. The first frequency f1 and the second frequency f2 are not particularly limited.

In the present embodiment, the controller 40 changes at least one of the length t1 of the first period PH11 and the length t2 of the second period PH21 according to at least one of the detected lamp voltage Vla and the driving power Wd supplied to the discharge lamp 90. As an example, Table 2 shows an example of a case of changing the length t1 of the first period PH11 and the length t2 of the second period PH21 according to the lamp voltage Vla. Table 2 also shows a time ratio Pt which is a ratio of the length t2 of the second period PH21 to the length t1 of the first period PH11.

Table 2 shows an example in which, in a case where the lamp voltage Vla is equal to or lower than 60 V or is higher than 100 V, for example, the first period PH11 is not provided, and only the second period PH21 is provided.

TABLE 2

| Lamp | Length | Length | Time ratio Pt (length t21 |
|---|---|---|---|
| voltage | t1 (ms) of | t2 (ms) of | of second period/lengths |
| Vla (V) | first period | second period | t11 and t12 of first period) |
| up to 60 | — | — | — |
| up to 70 | 50 | 50 | 1000 |
| up to 80 | 200 | 6 | 30 |
| up to 90 | 400 | 20 | 50 |
| up to 100 | 20 | 50 | 250 |
| 100 or more | — | — | — |

In Table 2, the length t1 of the first period PH11 increases in stages according to an increase in the lamp voltage Vla until the lamp voltage Vla reaches 90 V, and decreases if the lamp voltage Vla exceeds 90 V. In other words, the length t1 of the first period PH11 increases according to an increase in the lamp voltage Vla in a range in which the lamp voltage Vla is equal to or lower than a first predetermined voltage Vla1 (90 V in Table 2), and decreases according to the increase in the lamp voltage Vla in a range in which the lamp voltage Vla is higher than the first predetermined voltage Vla1.

In Table 2, the length t2 of the second period PH21 decreases in stages according to an increase in the lamp voltage Vla until the lamp voltage Vla reaches 80 V, and increases if the lamp voltage Vla exceeds 80 V. In other words, the length t2 of the second period PH21 decreases according to the increase in the lamp voltage Vla in a range in which the lamp voltage Vla is equal to or lower than a second predetermined voltage Vla2 (80 V in Table 2), and increases according to the increase in the lamp voltage Vla in a range in which the lamp voltage Vla is higher than the second predetermined voltage Vla2.

In Table 2, the first predetermined voltage Vla1 is 90 V, and the second predetermined voltage Vla2 is 80 V. In other words, the second predetermined voltage Vla2 is lower than the first predetermined voltage Vla1.

The length t1 of the first period PH11 may be changed, for example, by changing the number of repetitions of the cycle C11, and by changing the length of the cycle C11. The length t2 of the second period PH21 may be changed, for example, by changing the number of repetitions of the cycle C21, and by changing the length of the cycle C21.

The controller 40 changes the length t1 of the first period PH11 and the length t2 of the second period PH21 so as to change the time ratio Pt according to the lamp voltage Vla. In Table 2, the time ratio Pt decreases in stages according to an increase in the lamp voltage Vla until the lamp voltage Vla reaches 80 V, and increases if the lamp voltage Vla exceeds 80 V. In other words, the time ratio Pt decreases according to an increase in the lamp voltage Vla in a range in which the lamp voltage Vla is equal to or less than a predetermined value, and increases according to the increase in the lamp voltage Vla in a range in which the lamp voltage Vla is more than the predetermined value.

As described above, the controller 40 of the present embodiment controls the discharge lamp driving unit 230 so that the driving current I corresponding to each of the above-described periods is supplied to the discharge lamp 90.

The control on the discharge lamp driving unit 230 performed by the controller 40 may be expressed as a discharge lamp driving method. In other words, a discharge lamp driving method of the present embodiment includes driving the discharge lamp 90 by supplying the driving current I to the discharge lamp 90 including the first electrode 92 and the second electrode 93, in which the first period PH11 and the second period PH21 in which an AC current is supplied to the discharge lamp 90 are alternately repeated, in which the first period PH11 includes a plurality of consecutive first unit driving periods U11 and U12 constituted of the first polarity periods P11a and P12a in which the first electrode 92 serves as an anode and the second polarity periods P11b and P12b in which the second electrode 93 serves as an anode, in which the second period PH21 includes a plurality of consecutive second unit driving periods U21 and U22 constituted of the first polarity periods P21a and P22a in which the first electrode 92 serves as an anode and the second polarity periods P21b and P22b in which the second electrode 93 serves as an anode, in which, in the first unit driving periods U11 and U12, a length of one of the first polarity periods P11a and P12a and the second polarity periods P11b and P12b is larger than a length of the other polarity period, and the retention duration ratio Pkt which is a ratio of the length of one polarity period to the length of the other polarity period is equal to or more than the predetermined value X, and in which, in the second unit driving periods U21 and U22, the retention duration ratio Pkt is equal to or more than 1, and is less than the predetermined value X.

According to the present embodiment, in the first unit driving periods U11 constituting the first period PH11 (first AC period PH11a), the retention duration ratio Pkt is more than the predetermined value X. Therefore, in the first period PH11 (first AC period PH11a), a sum of the lengths t11a of the first polarity periods P11a is larger than a sum of the lengths t11b of the second polarity periods P11b, and thus it is possible to improve a melting amount of the protrusion 552p of the first electrode 92 serving as an anode in the first polarity periods P11a.

On the other hand, the second polarity period P11b which is shorter than the first polarity period P11a and in which an opposite polarity occurs is provided in each of the plurality of first unit driving periods U11 included in the first AC period PH11a, and thus it is possible to minimize a decrease in the temperature of the second electrode 93 serving as an anode in the second polarity period P11b. Consequently, it is possible to prevent the protrusion 562p of the second electrode 93 from being deformed and thus to minimize the occurrence of flickering. This is also the same for the second AC period PH11b except that a polarity is inverted.

Therefore, according to the present embodiment, since a melting amount of the protrusion at the tip of the electrode on the heated side can be improved, and the protrusion at the tip of the electrode on the opposite side to the heated side can be prevented from being deformed so that the occurrence of flickering is minimized, it is possible to provide the discharge lamp driving device capable of improving the lifespan of the discharge lamp 90.

According to the present embodiment, the second period PH21 including the consecutive second unit driving periods U21 and U22 in which the retention duration ratio Pkt is equal to or more than 1 and is less than the predetermined value X, is provided. Therefore, in the second period PH21, a relatively small heat load can be applied to both of the first electrode 92 and the second electrode 93 to the same extent. Consequently, an appropriate heat load can be applied to the protrusion melted in the first period PH11, and the protrusion can be made to grow. Therefore, the tip is rounded, and thus it is possible to easily form the thick and stable protrusion.

As mentioned above, according to the present embodiment, the first period PH11 and the second period PH21 are alternately repeated, and thus it is possible to stably maintain the shape of the first electrode 92 and the shape of the second electrode 93 and thus to further improve the lifespan of the discharge lamp 90.

According to the present embodiment, the second period PH21 includes the first frequency period Pf1 and the second frequency period Pf2 in which frequencies of an AC current supplied to the discharge lamp 90 are different from each other. In the first frequency period Pf1 and the second frequency period Pf2, the length of the first polarity period is the same as the length of the second polarity period in the second unit driving period. Therefore, it is possible to apply a heat load to both of the protrusion 552p of the first electrode 92 and the protrusion 562p of the second electrode 93 to the same extent and thus to make both of the protrusions to stably grow. Since a frequency of an AC current supplied to the discharge lamp 90 changes, changes in stimuli due to appropriate heat loads can be provided to the first electrode 92 and the second electrode 93, and thus it becomes easier to make the protrusions 552p and 562p grow.

According to the present embodiment, a frequency of an AC current supplied to the discharge lamp 90 in the second period PH21 temporally increases and decreases. Consequently, it is possible to appropriately change a heat load applied to the first electrode 92 and the second electrode 93 and thus it becomes easier to make the protrusions 552p and 562p grow.

According to the present embodiment, the first period PH11 includes the first AC period PH11a and the second AC period PH11b, and the first AC period PH11a and the second AC period PH11b are alternately provided with the second period PH21 interposed therebetween. A polarity in the second AC period PH11b is inverse to a polarity in the first AC period PH11a. Thus, it is possible to improve a melting amount of the first electrode 92 in the first AC period PH11a and also to improve a melting amount of the second electrode 93 in the second AC period PH11b. Therefore, according to the present embodiment, it is possible to stably maintain the protrusion 552p of the first electrode 92 and the protrusion 562p of the second electrode 93 with good balance.

According to the present embodiment, the length t1 of the first period PH11 and the length t2 of the second period PH21 are changed according to at least one of the lamp voltage Vla and the driving power Wd. Thus, it is possible to appropriately adjust a heat load applied to the first electrode 92 and the second electrode 93 in accordance with deterioration in the discharge lamp 90 and a change in the driving power Wd.

In a state in which the discharge lamp 90 is close to an initial state (a state in which the discharge lamp 90 does not deteriorate), the protrusion 552p of the first electrode 92 easily grows, and thus it is not necessary to apply a large heat load to the first electrode 92. In contrast, if a large heat load is applied to the first electrode 92, the protrusion 552p is too melted, and thus there is a concern that growth of the protrusion 552p may be impeded. Consequently, in a state in which the discharge lamp 90 does not deteriorate, it is preferable to apply a relatively small heat load to the first electrode 92.

If the deterioration in the discharge lamp 90 progresses to some extent, the protrusion 552p of the first electrode 92 is hardly melted. Thus, a heat load applied to the first electrode 92 is preferably made large according to the deterioration in the discharge lamp 90.

If the deterioration in the discharge lamp 90 further progresses, the protrusion 552p is easily thinned, and thus there is a concern that the protrusion 552p may be lost if a heat load applied to the first electrode 92 is large. Thus, a heat load applied to the first electrode 92 is preferably small after the deterioration in the discharge lamp 90 progresses to some extent.

In relation to this fact, according to the present embodiment, the length t1 of the first period PH11 increases according to an increase in the lamp voltage Vla in a range in which the lamp voltage Vla is equal to or lower than the first predetermined voltage Vla1, and decreases according to the increase in the lamp voltage Vla in a range in which the lamp voltage Vla is higher than the first predetermined voltage Vla1. As the length t1 of the first period PH11 increases, a heat load applied to the first electrode 92 becomes larger.

Therefore, a heat load applied to the first electrode 92 can be made relatively small in a state in which the discharge lamp 90 does not deteriorate, and a heat load can be made large in accordance with the deterioration if the discharge lamp 90 starts to deteriorate. A heat load applied to the first electrode 92 can be made relatively small after the deterioration in the discharge lamp 90 progresses to some extent. Therefore, according to the present embodiment, it is possible to appropriately adjust a heat load applied to the first electrode 92 according to the deterioration in the discharge lamp 90.

As the number of first periods PH11 provided within a predetermined period of time is increased, a heat load applied to the first electrode 92 within the predetermined period of time becomes larger. The number of first periods PH11 provided within the predetermined period of time is changed depending on, for example, the length t2 of the second period PH21. In other words, as the length t2 of the second period PH21 is increased, the number of first periods PH11 provided within the predetermined period of time is reduced since a period of time from ending of the first period PH11 to starting of the next first period PH11 is lengthened. Therefore, as the length t2 of the second period PH21 is increased, a heat load applied to the first electrode 92 within the predetermined period of time becomes smaller, and as the length t2 of the second period PH21 is decreased, a heat load applied to the first electrode 92 within the predetermined period of time becomes larger.

Therefore, as shown in Table 2, the length t2 of the second period PH21 decreases according to an increase in the lamp voltage Vla in a range in which the lamp voltage Vla is equal to or lower than the second predetermined voltage Vla2, and increases according to the increase in the lamp voltage Vla in a range in which the lamp voltage Vla is higher than the second predetermined voltage Vla2, and thus it is possible to more appropriately adjust a heat load applied to the first electrode 92.

Here, in the second period PH21, the protrusion 552p of the first electrode 92 melted in the first period PH11 grows. In a case where the lamp voltage Vla increases due to the deterioration in the discharge lamp 90, the protrusion 552p hardly grows, and thus there is a concern that the protrusion 552p may insufficiently grow if the length t2 of the second period PH21 is too small.

In relation to this fact, according to the present embodiment, as shown in Table 2, the length t1 of the first period PH11 increases until the lamp voltage Vla reaches 90 V, and, in contrast, the length t2 of the second period PH21 decreases until the lamp voltage Vla reaches 80 V, and increases in a range in which the lamp voltage Vla exceeds 80 V.

As mentioned above, in a case where the discharge lamp 90 deteriorates to some extent, and the lamp voltage Vla increases to some extent, the length t1 of the first period PH11 is increased so that a heat load applied to the first electrode 92 is large, and the length t2 of the second period PH21 is also increased to some extent, and thus it is possible to make the protrusion 552p of the first electrode 92 grow more effectively.

In the present embodiment, the following configurations and methods may be employed. In the following description, the same constituent elements as described above are given the same reference numerals as appropriate, and description thereof will be omitted in some cases.

In the present embodiment, the controller 40 may change at least one of the length t1 of the first period PH11 and the length t2 of the second period PH21 according to the driving power Wd. Table 3 shows an example of a case where the controller 40 changes the length t1 of the first period PH11 according to the driving power Wd.

TABLE 3

| Driving power Wd (W) | Length t1 (ms) of first period |
|---|---|
| 200 | 200 |
| 170 | 375 |
| 140 | 625 |

In Table 3, the length t1 of the first period PH11 increases according to a decrease in the driving power Wd.

For example, in a case where the driving power Wd is relatively low, the driving current I supplied to the discharge lamp 90 is reduced, and thus a heat load applied to the first electrode 92 is relatively small. Consequently, there is a concern that the protrusion 552p of the first electrode 92 may be insufficiently melted. On the other hand, in a case where the driving power Wd is relatively high, the driving current I supplied to the discharge lamp 90 increases, a heat load applied to the first electrode 92 is relatively large. Consequently, there is a concern that the protrusion 552p of the first electrode 92 may be excessively melted.

In relation to this fact, if the length t1 of the first period PH11 is increased according to a decrease in the driving power Wd, a heat load applied to the first electrode 92 can be made large by increasing the length t1 of the first period PH11 in a case where the driving power Wd is relatively low. In a case where the driving power Wd is relatively high, a heat load applied to the first electrode 92 can be made small by reducing the length t1 of the first period PH11. Therefore, with this configuration, it is possible to appropriately adjust the length t1 of the first period PH11 according to a change in the driving power Wd, and thus to appropriately melt the protrusion 552p.

In this configuration, in a case where the length t2 of the second period PH21 is changed according to the driving power Wd, for example, the length t2 of the second period PH21 is reduced according to a decrease in the driving power Wd. Due to the above, in a case where the driving power Wd is low, the number of first periods PH11 provided within a predetermined period of time can be increased, and, in a case where the driving power Wd is high, the number of first periods PH11 provided within the predetermined period of time can be decreased. Therefore, it is possible to appropriately melt the protrusion 552p according to a change in the driving power Wd.

In the present embodiment, both of the length t1 of the first period PH11 and the length t2 of the second period PH21 may be changed, and only one of the length t1 of the first period PH11 and the length t2 of the second period PH21 may be changed, according to both of the lamp voltage Vla and the driving power Wd.

In the present embodiment, the controller 40 may change the retention duration ratio Pkt in the first period PH11 according to at least one of the lamp voltage Vla and the driving power Wd. As an example, an example in which the controller 40 changes the retention duration ratio Pkt according to the lamp voltage Vla is shown in Table 4. Table 4 also shows an average length of the first polarity periods P11a.

Table 4 shows an example in which, in a case where the lamp voltage Vla is equal to or lower than 60 V or is higher than 100 V, for example, the first period PH11 is not provided, and only the second period PH21 is provided.

TABLE 4

| Lamp | Retention duration ratio Pkt (length t11a | Average length |
|---|---|---|
| voltage | of first polarity period/length t11b of | (ms) of first |
| Vla (V) | second polarity period) | polarity period |
| up to 60 | — | — |
| up to 70 | 10 | 4 |
| up to 80 | 15 | 6 |
| up to 90 | 20 | 8 |
| up to 100 | 15 | 6 |
| 100 or more | — | — |

In Table 4, the retention duration ratio Pkt increases in stages according to an increase in the lamp voltage Vla until the lamp voltage Vla reaches 90 V, and decreases if the lamp voltage Vla exceeds 90 V. In other words, the retention duration ratio Pkt increases according to an increase in the lamp voltage Vla in a range in which the lamp voltage Vla is equal to or lower than a third predetermined voltage Vla3 (90 V in Table 4), and decreases according to the increase in the lamp voltage Vla in a range in which the lamp voltage Vla is higher than the third predetermined voltage Vla3.

The retention duration ratio Pkt may be changed, for example, by changing the length t11a of the first polarity period P11a. In other words, as shown in Table 4, the average length of the first polarity period P11a is changed according to a change in the lamp voltage Vla, and thus the retention duration ratio Pkt is changed as described above. In this case, the length t11b of the second polarity period P11b is constant, for example.

As the retention duration ratio Pkt increases, a ratio of the first polarity period P11a in the first unit driving period U11 increases. Thus, a sum of the lengths t11a of the first polarity periods P11a occupying the first period PH11 (the first AC period PH11a) increases. Consequently, a heat load applied to the first electrode 92 in the first period PH11 increases in proportion to an increase in the retention duration ratio Pkt.

Therefore, it is possible to appropriately change a heat load applied to the first electrode 92 by changing the retention duration ratio Pkt in the first period PH11 according to at least one of the lamp voltage Vla and the driving power Wd. The retention duration ratio Pkt is changed as described above according to a change in the lamp voltage Vla, and thus it is possible to appropriately adjust a heat load applied to the first electrode 92 in the same manner as in the change in the length t1 of the first period PH11.

As another example, Table 5 shows an example in which the controller 40 changes the retention duration ratio Pkt according to the driving power Wd. Table 5 also shows an average length of the first polarity periods P11a.

TABLE 5

| Driving | Retention duration ratio Pkt (length t11a | Average length |
|---|---|---|
| power Wd | of first polarity period/length t11b of | (ms) of first |
| (W) | second polarity period) | polarity period |
| 200 | 15 | 6 |
| 170 | 17 | 7 |
| 140 | 20 | 8 |

In Table 5, the duration retention ratio Pkt increases according to a decrease in the driving power Wd. Consequently, it is possible to appropriately change a heat load applied to the first electrode 92 for a change in the driving power Wd in the same manner as in the above-described change in the length t1 of the first period PH11 for a change in the driving power Wd. In this case, an average length of the first polarity period P11a increases according to a decrease in the driving power Wd. Consequently, the controller 40 changes the retention duration ratio Pkt.

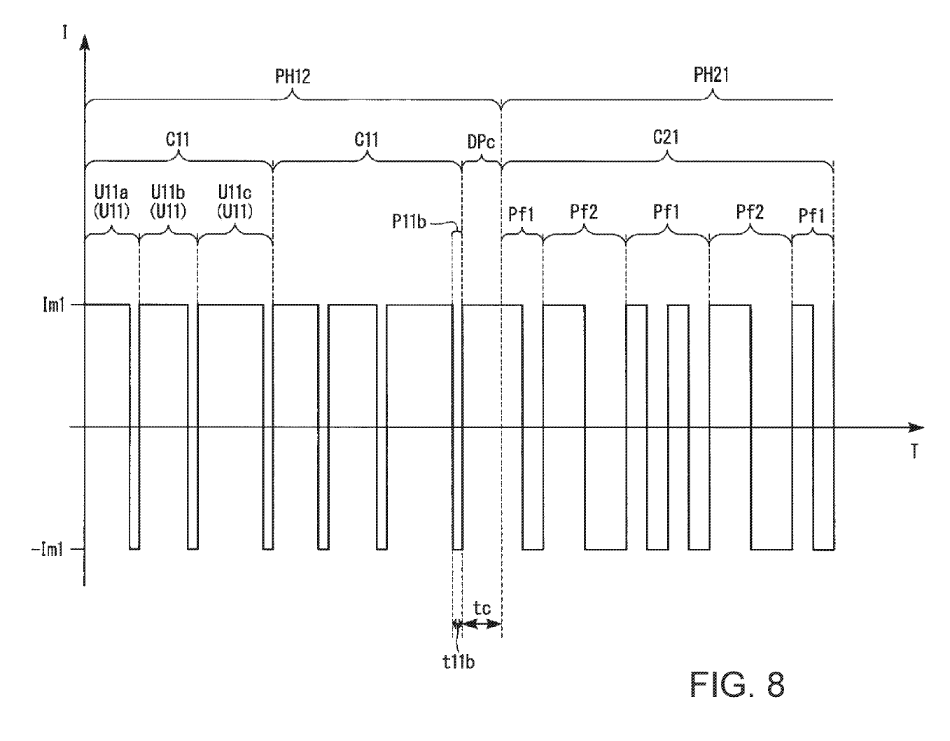

In the present embodiment, the driving current I supplied to the discharge lamp 90 may have a driving current waveform as illustrated in FIG. 8. FIG. 8 is a diagram illustrating another example of a driving current waveform of the present embodiment.

As illustrated in FIG. 8, a first period PH12 has an adjustment period DPc. The adjustment period DPc is provided right before transition to the second period PH21 from the first period PH12. The adjustment period DPc is located between the cycle C11 and the cycle C21. The adjustment period DPc is a period in which a DC current with a polarity causing an electrode on a heated side in the first period PH12 to serve as an anode, that is, the DC current of the first polarity is supplied to the discharge lamp 90 in the example illustrated in FIG. 8.

For example, a length tc of the adjustment period DPc is larger than the length t11b of the second polarity period P11b provided right before the adjustment period DPc, and is set so that a ratio thereof to the t11b of the second polarity period P11b is larger than the predetermined value X.

With this configuration, the adjustment period DPc is provided, and thus both of a starting polarity and a last polarity can be made a polarity (first polarity) causing an electrode on a heated side to serve as an anode in the first period PH12. Thus, the second period PH21 can be started in a state in which the electrode on the heated side is heated in the adjustment period DPc. Consequently, it is possible to more easily make the protrusion of the electrode grow in the second period PH21.

In the present embodiment, the number of repetitions of each cycle is not particularly limited. A configuration of each cycle may change over time. The first period PH11 and the second period PH21 may have a configuration in which the number of repetitions of each cycle is 0, and each of the cycle C11 and the cycle C21 may be included alone. In the first period PH11 and the second period PH21, a configuration of each unit driving period and a configuration of each frequency period may not be changed periodically but may be changed irregularly according to a cycle.

In the present embodiment, the retention duration ratio Pkt in the second unit driving periods U21 and U22 may not be 1. In this case, preferably, longer periods of the first polarity period and the second polarity period are replaced with each other as appropriate, and thus a heat load applied to the first electrode 92 and a heat load applied to the second electrode 93 are substantially the same as each other in the second period PH22.

### Second Embodiment

A second embodiment is different from the first embodiment in that DC periods PDa and PDb are provided in a second period PH22. The same constituent elements as in the above-described embodiment are given the same reference numerals, and description thereof will be omitted in some cases.

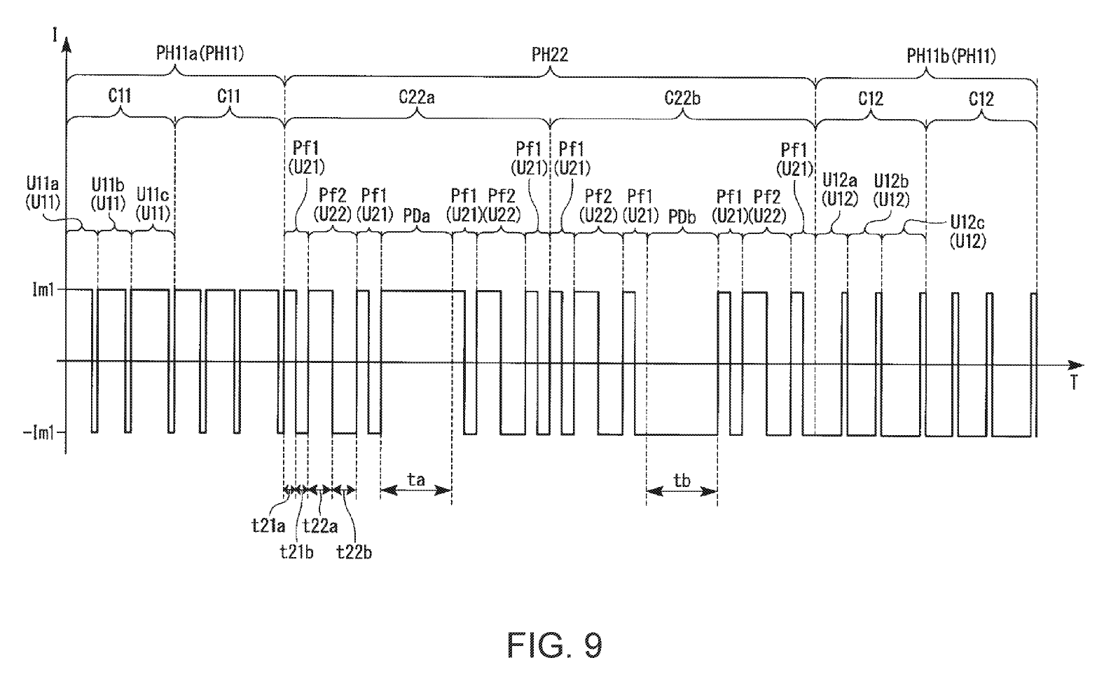

FIG. 9 is a diagram illustrating a driving current waveform of the driving current I supplied to the discharge lamp 90 of the present embodiment. In FIG. 9, a longitudinal axis expresses the driving current I, and a transverse axis expresses time T. As illustrated in FIG. 9, the second period PH22 includes a first frequency period Pf1, a second frequency period Pf2, and DC periods PDa and PDb.

The DC periods PDa and PDb are periods in which a DC current is supplied to the discharge lamp 90. In other words, in the DC periods PDa and PDb, the driving current I with either the first polarity or the second polarity is supplied to the discharge lamp 90.

A DC current supplied to the discharge lamp 90 in the DC periods PDa has the first polarity. A DC current supplied to the discharge lamp 90 in the DC periods PDb has the second polarity.

The DC periods PDa and PDb may be said to be periods in which a half cycle of an AC current is supplied to the discharge lamp 90. In this case, a length to of the DC periods PDa in which a DC current is supplied to the discharge lamp 90 is a length of a half cycle of an AC current with a third frequency f3, supplied to the discharge lamp 90 in the DC periods PDa. A length tb of the DC periods PDb in which a DC current is supplied to the discharge lamp 90 is a length of a half cycle of an AC current with the third frequency f3, supplied to the discharge lamp 90 in the DC periods PDb. The length ta and the length tb may be different from or the same as each other.

Each of the length ta of the DC periods PDa and the length tb of the DC periods PDb is larger than each of the length t21a of the first polarity period P21a, the length t22a of the first polarity period P22a, the length t21b of the second polarity period P21b, and the length t22b of the second polarity period P22b. In the present embodiment, in the first frequency period Pf1 and the second frequency period Pf2 of the second period PH22, the retention duration ratio Pkt which is a ratio of the length t21a of the first polarity period P21a to the length t21b of the second polarity period P21b is 1, and each of the length ta of the DC periods PDa and the length tb of the DC periods PDb is larger than a length of a half cycle of an AC current with the first frequency f1 supplied to the discharge lamp 90 in the first frequency period Pf1 and a length of a half cycle of an AC current with the second frequency f2 supplied to the discharge lamp 90 in the second frequency period Pf2. In other words, the third frequency f3 is lower than each of the first frequency f1 and the second frequency f2.

The controller 40 changes the lengths ta and tb of the DC periods PDa and PDb according to at least one of the lamp voltage Vla and the driving power Wd. In other words, the controller 40 changes the third frequency f3 of the AC current supplied to the discharge lamp 90 in the DC periods PDa and PDb according to at least one of the lamp voltage Vla and the driving power Wd.

Specifically, for example, each of the lengths to and tb of the DC periods PDa and PDb increases according to an increase in the lamp voltage Vla in a range in which the lamp voltage Vla is equal to or less than a predetermined value, and decreases according to the increase in the lamp voltage Vla in a range in which the lamp voltage Vla is more than the predetermined value.

The second period PH22 includes a cycle C22a constituted of the first frequency period Pf1, the second frequency period Pf2, and the DC periods PDa, and a cycle C22b constituted of the first frequency period Pf1, the second frequency period Pf2, and the DC periods PDb. The cycle C22a and the cycle C22b are the same as each other, for example, except that DC periods therein are different from each other as the DC periods PDa and the DC periods PDb, respectively.

The cycle C22a and the cycle C22b are continuously provided. In FIG. 9, each of the cycle C22a and the cycle C22b is provided alone, but may be provided in plurality. In this case, the cycle C22a and the cycle C22b are alternately repeated, for example.

According to the present embodiment, since the second period PH22 has the DC periods PDa and PDb, heat loads applied to the first electrode 92 and the second electrode 93 in the second period PH22 can be increased. Consequently, stimuli due to appropriate heat loads can be provided to the first electrode 92 and the second electrode 93, and the protrusions 552p and 562p can also be made to grow. Therefore, it is possible to easily maintain the protrusions 552p and 562p to have thicker and more stable shapes, and it is possible to further improve the lifespan of the discharge lamp 90.

According to the present embodiment, the lengths to and tb of the DC periods PDa and PDb are changed depending on at least one of the lamp voltage Vla and the driving power Wd. Thus, it is possible to appropriately adjust heat loads applied to the first electrode 92 and the second electrode 93 in the second period PH22 according to changes in the lamp voltage Vla and the driving power Wd.

In the present embodiment, only one of the DC periods PDa and the DC periods PDb may be provided in a single second period PH22. In this case, for example, the DC periods PDa and the DC periods PDb are alternately provided whenever the second period PH22 is provided.

The configurations of the first and second embodiments may be combined with each other so as not to cause contradiction therebetween.

In the respective embodiments, a description has been made of an example of a case where the invention is applied to the transmissive projector, but the invention is applicable to a reflective projector. Here, the term “transmissive” indicates a type in which a liquid crystal light valve including a liquid crystal panel or the like transmits light therethrough. The term “reflective” indicates a type in which the liquid crystal light valve reflects light. A light modulation device is not limited to a liquid crystal panel or the like, and may be a light modulation device using, for example, a micro-mirror.

In the respective embodiments, a description has been made of an example of the projector 500 using the three liquid crystal panels 560R, 560G and 560B (the liquid crystal light valves 330R, 330G and 330B), but the invention is applicable to a projector using only a single liquid crystal panel, and to a projector using four or more liquid crystal panels.

The entire disclosure of Japanese Patent Application No. 2015-179710, filed Sep. 11, 2015 is expressly incorporated by reference herein.

What is claimed is:

1. A discharge lamp driving device comprising:
a discharge lamp driving unit configured to supply a driving current to a discharge lamp provided with a first electrode and a second electrode; and
a controller configured to control the discharge lamp driving unit,
wherein the controller is configured to supply the driving current to the discharge lamp, the driving current alternately having a first period and a second period in which an AC current is supplied to the discharge lamp,
wherein the first period includes a plurality of consecutive first unit driving periods each of which is constituted of a first polarity period in which the first electrode serves as an anode and a second polarity period in which the second electrode serves as an anode,
wherein the second period includes a plurality of consecutive second unit driving periods each of which is constituted of the first polarity period and the second polarity period,
wherein, in the first unit driving period, a length of one of the first polarity period and the second polarity period is larger than the other polarity period, and a duration ratio which is a ratio of the length of the one polarity period to the length of the other polarity period is equal to or more than a predetermined value, and
wherein, in the second unit driving period, the duration ratio is equal to or more than 1, and is less than the predetermined value.

2. The discharge lamp driving device according to claim 1,
wherein the second period has a first frequency period and a second frequency period each of which includes at least one second unit driving period in which the duration ratio is 1, and
wherein a first frequency of an AC current in the first frequency period is different from a second frequency of an AC current in the second frequency period.

3. The discharge lamp driving device according to claim 2,
wherein, in the second period, a frequency of the AC current supplied to the discharge lamp temporally changes.

4. The discharge lamp driving device according to claim 2,
wherein the second period has a DC period in which a DC current is supplied to the discharge lamp, and
wherein a length of the DC period is larger than a length of a half cycle of an AC current with the first frequency and a length of a half cycle of an AC current with the second frequency.

5. The discharge lamp driving device according to claim 1,
wherein the first period includes a first AC period in which the length of the first polarity period is larger than the length of the second polarity period in the first unit driving period, and a second AC period in which the length of the second polarity period is larger than the length of the first polarity period in the first unit driving period, and
wherein the first AC period and the second AC period are alternately provided with the second period interposed therebetween.

6. The discharge lamp driving device according to claim 1, further comprising:
a detection unit configured to detect an inter-electrode voltage of the discharge lamp,
wherein the controller changes at least one of the length of the first period and the length of the second period according to at least one of detected inter-electrode voltage and driving power supplied to the discharge lamp.

7. The discharge lamp driving device according to claim 6,
wherein the controller changes the length of the first period according to the detected inter-electrode voltage, and
wherein the length of the first period is increased according to an increase of the inter-electrode voltage in a range in which the inter-electrode voltage is equal to or lower than a first predetermined voltage, and is decreased according to the increase of the inter-electrode voltage in a range in which the inter-electrode voltage is higher than the first predetermined voltage.

8. The discharge lamp driving device according to claim 7,
wherein the controller changes the length of the second period according to the detected inter-electrode voltage, and
wherein the length of the second period is decreased according to an increase of the inter-electrode voltage in a range in which the inter-electrode voltage is equal to or lower than a second predetermined voltage, and is increased according to the increase of the inter-electrode voltage in a range in which the inter-electrode voltage is higher than the second predetermined voltage.

9. The discharge lamp driving device according to claim 8,
wherein the second predetermined voltage is lower than the first predetermined voltage.

10. The discharge lamp driving device according to claim 1, further comprising:
a detection unit configured to detect an inter-electrode voltage of the discharge lamp,
wherein the controller changes the duration ratio in the first period according to at least one of detected inter-electrode voltage and driving power supplied to the discharge lamp.

11. The discharge lamp driving device according to claim 10,
wherein the controller changes the duration ratio according to the detected inter-electrode voltage, and
wherein the duration ratio is increased according to an increase of the inter-electrode voltage in a range in which the inter-electrode voltage is equal to or lower than a third predetermined voltage, and is decreased according to the increase of the inter-electrode voltage in a range in which the inter-electrode voltage is higher than the third predetermined voltage.

12. The discharge lamp driving device according to claim 4, further comprising:
a detection unit configured to detect an inter-electrode voltage of the discharge lamp,
wherein the controller changes the length of the DC period according to at least one of detected inter-electrode voltage and driving power supplied to the discharge lamp.

13. A projector comprising:
a discharge lamp configured to emit light;
the discharge lamp driving device according to claim 1;
a light modulation device configured to modulate light emitted from the discharge lamp according to an image signal; and
a projection optical system configured to project light modulated by the light modulation device.

14. A projector comprising:
a discharge lamp configured to emit light;
the discharge lamp driving device according to claim 2;
a light modulation device configured to modulate light emitted from the discharge lamp according to an image signal; and
a projection optical system configured to project light modulated by the light modulation device.

15. A projector comprising:
a discharge lamp configured to emit light;
the discharge lamp driving device according to claim 3;
a light modulation device configured to modulate light emitted from the discharge lamp according to an image signal; and
a projection optical system configured to project light modulated by the light modulation device.

16. A projector comprising:
a discharge lamp configured to emit light;
the discharge lamp driving device according to claim 4;
a light modulation device configured to modulate light emitted from the discharge lamp according to an image signal; and
a projection optical system configured to project light modulated by the light modulation device.

17. A projector comprising:
a discharge lamp configured to emit light;
the discharge lamp driving device according to claim 5;
a light modulation device configured to modulate light emitted from the discharge lamp according to an image signal; and
a projection optical system configured to project light modulated by the light modulation device.

18. A projector comprising:
a discharge lamp configured to emit light;
the discharge lamp driving device according to claim 6;
a light modulation device configured to modulate light emitted from the discharge lamp according to an image signal; and
a projection optical system configured to project light modulated by the light modulation device.

19. A projector comprising:
a discharge lamp configured to emit light;
the discharge lamp driving device according to claim 7;
a light modulation device configured to modulate light emitted from the discharge lamp according to an image signal; and
a projection optical system configured to project light modulated by the light modulation device.

20. A discharge lamp driving method for supplying a driving current to a discharge lamp provided with a first electrode and a second electrode and driving the discharge lamp, the method comprising:
repeating alternately a first period and a second period in which an AC current is supplied to the discharge lamp,
wherein the first period includes a plurality of consecutive first unit driving periods each of which is constituted of a first polarity period in which the first electrode serves as an anode and a second polarity period in which the second electrode serves as an anode,
wherein the second period includes a plurality of consecutive second unit driving periods each of which is constituted of the first polarity period and the second polarity period,
wherein, in the first unit driving period, a length of one of the first polarity period and the second polarity period is larger than the other polarity period, and a duration ratio which is a ratio of the length of the one polarity period to the length of the other polarity period is equal to or more than a predetermined value, and
wherein, in the second unit driving period, the duration ratio is equal to or more than 1, and is less than the predetermined value.
